(19) United States
(12) Patent Application Publication
(10) Pub. No.: US 2016/0196506 A1
(43) Pub. Date: Jul. 7, 2016

(54) INCREMENTAL LEARNING MANAGEMENT DEVICE, INCREMENTAL LEARNING MANAGEMENT METHOD AND COMPUTER READABLE RECORDING MEDIUM STORING INCREMENTAL LEARNING MANAGEMENT PROGRAM

(71) Applicant: FUJITSU LIMITED, Kawasaki-shi (JP)

(72) Inventors: Emeric Viel, Yokohama (JP); Haruyasu Ueda, Ichikawa (JP)

(73) Assignee: FUJITSU LIMITED, Kawasaki-shi (JP)

(21) Appl. No.: 14/970,728

(22) Filed: Dec. 16, 2015

(30) Foreign Application Priority Data
Jan. 6, 2015 (JP) 2015-000885

(51) Int. Cl. G06N 99/00

(52) U.S. Cl. CPC G06N 99/005

(57) ABSTRACT

An incremental learning management method includes: extracting data by a computer from input data that are sequentially input based on a first window size and a first sampling rate; storing learning history information in which the first window size is associated with a learning time for the data and the first sampling rate; measuring a data rate of the input data; and calculating a second window size and a second sampling rate based on the data rate, the learning history information, and the first sampling rate.

### CROSS-REFERENCE TO RELATED APPLICATION

This application is based upon and claims the benefit of priority of the prior Japanese Patent Application No. 2015-000885, filed on Jan. 6, 2015, the entire contents of which are incorporated herein by reference.

### FIELD

The embodiments discussed herein are related to an incremental learning management device, an incremental learning management method and a computer readable recording medium storing incremental learning management program.

### BACKGROUND

Machine learning has been attracting attention for its ability to gain new knowledge and information that are useful for business from a large amount of time-series data arising from the Internet and various kinds of sensors. Achievement of both of short learning time and high accuracy is important in machine learning when dealing with a large amount of time-series data.

Zhao, J. “Parallelized incremental support vector machines based on MapReduce and Bagging technique”, 2012 discloses a related art.

### SUMMARY

According to an aspect of the embodiments, an incremental learning management method includes: extracting data by a computer from input data that are sequentially input based on a first window size and a first sampling rate; storing learning history information in which the first window size is associated with a learning time for the data and the first sampling rate; measuring a data rate of the input data; and calculating a second window size and a second sampling rate based on the data rate, the learning history information, and the first sampling rate.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates one example of relationship between learning time and accuracy;

FIG. 2 illustrates one example of combining of a window size with a model in incremental learning;

FIG. 3 illustrates one example of relationship between window size, learning speed, and input rate;

FIG. 4 illustrates one example of relationship between window size, learning speed, and input rate;

FIG. 5 illustrates one example of incremental learning;

FIG. 6 illustrates one example of relationship between learning speed and input rate;

FIG. 7 illustrates one example of relationship between sampling rate, learning speed, and input rate;

FIG. 8 illustrates one example of relationship between a change of sampling rate and accuracy;

FIG. 9 illustrates one example of relationship between a change of sampling rate and window size;

FIG. 10 illustrates one example of a configuration of an incremental learning management device;

FIG. 11 illustrates one example of a learning history information table;

FIG. 12 illustrates one example of a learning time prediction model table;

FIG. 13 illustrates one example of an accuracy history information table;

FIG. 14 illustrates one example of an accuracy prediction model table;

FIG. 15 illustrates one example of a window size/sampling rate (N/S) setting process;

FIG. 16 illustrates one example of an input buffer output process;

FIG. 17 illustrates one example of a learning time measurement process;

FIG. 18 illustrates one example of a learning time modeling process;

FIGS. 19A and 19B illustrate one example of a search process;

FIG. 20 illustrates examples of a rightward search and a leftward search of an N/S search process;

FIGS. 21A to 21C illustrate one example of an N/S rightward search process;

FIGS. 22A to 22C illustrate one example of an N/S leftward search process;

FIG. 23 illustrates one example of an optimization control process;

FIG. 24 illustrates one example of optimized N/S; and

FIG. 25 illustrates one example of a hardware configuration of an incremental learning management device.

### DESCRIPTION OF EMBODIMENT

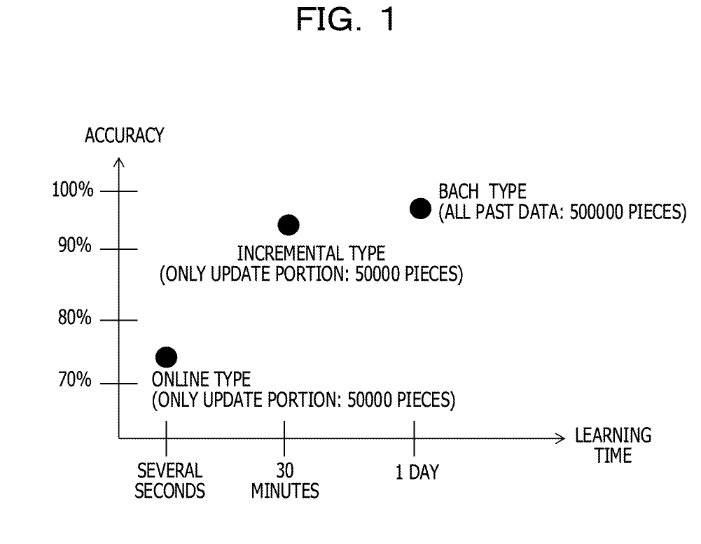

FIG. 1 illustrates one example of relationship between learning time and accuracy. As illustrated in FIG. 1, machine learning includes three types of learning methods, which are “batch learning”, “online learning”, and “incremental learning”. In view of the balance between the accuracy and the learning speed, the superiority between two learning methods of the incremental type and the online type changes in response to the input rate of learning data. FIG. 1 illustrates the relationship between performance (learning time) of each learning method and the accuracy.

In a case where the input rate is high (for example, several thousand to several ten thousand pieces/second), the online learning method in which data for recent update are learned in several milliseconds is selected. The incremental learning method exhibits higher accuracy than the online learning unless the input rate exceeds a specific value (for example, several ten to several hundred pieces/second).

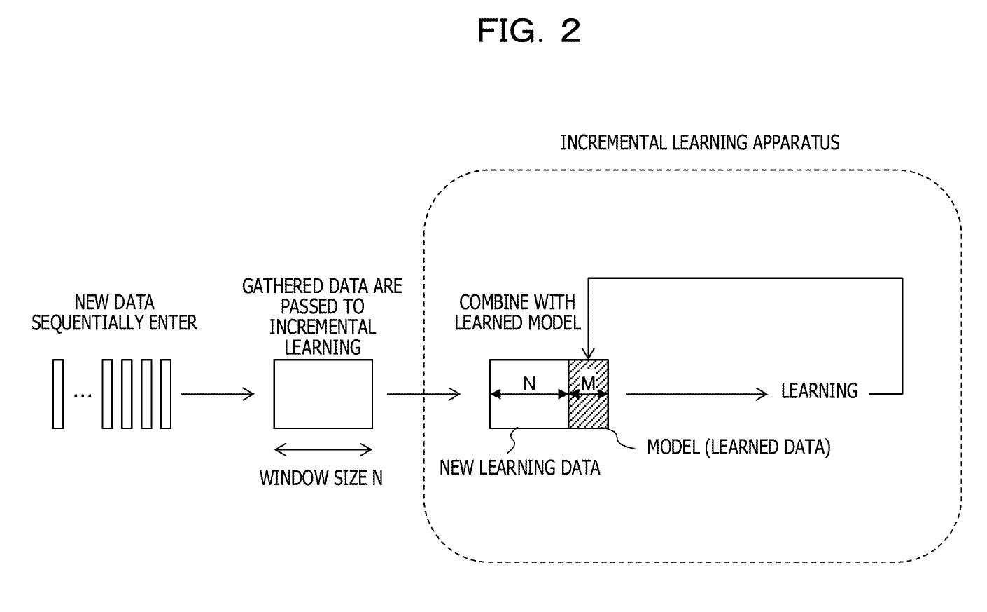

With the “incremental learning” method, almost equivalent accuracy to the batch learning is maintained, and learning is continued by using a previous result, without starting learning from scratch at each time when data arise. FIG. 2 illustrates one example of combining of a window size with a model with incremental learning. With the incremental type of machine learning, data that are sequentially input in real time are divided as illustrated in FIG. 2, and gathered data are passed to an incremental learning apparatus. The way of division may hereinafter be referred to as “window size”. For example, in one incremental learning apparatus, M pieces of learned model data, which are learning results so far obtained, are combined with N pieces of new learning data, and an incremental learning process is executed by an incremental learning algorithm. In this case, the M pieces of learned model data may cause a certain amount of overhead (time used for relearning of models).

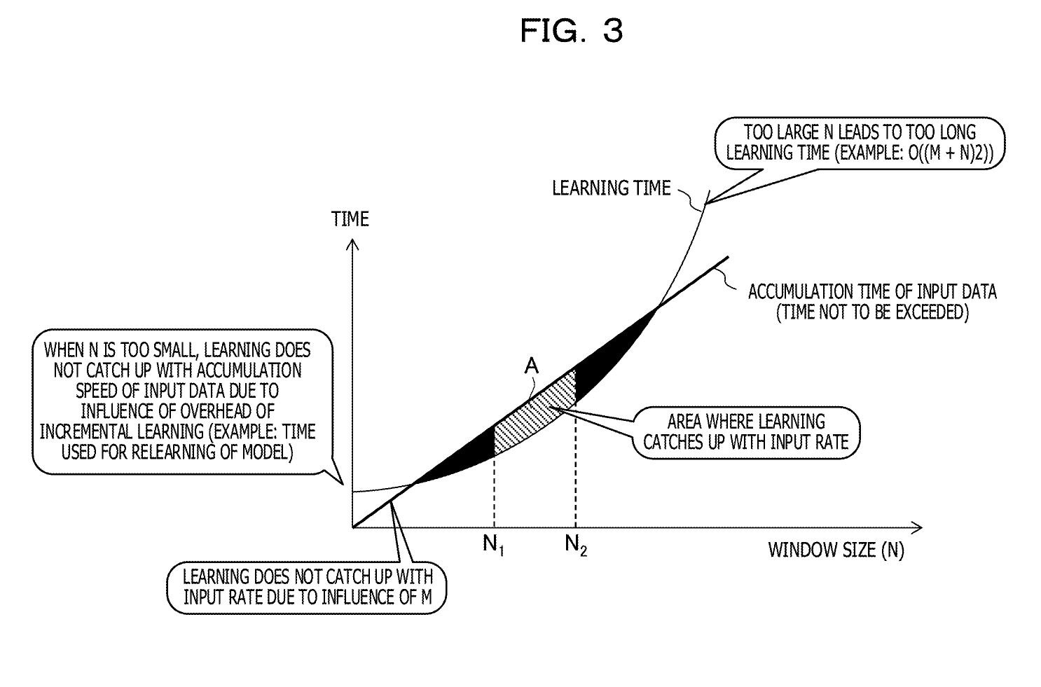

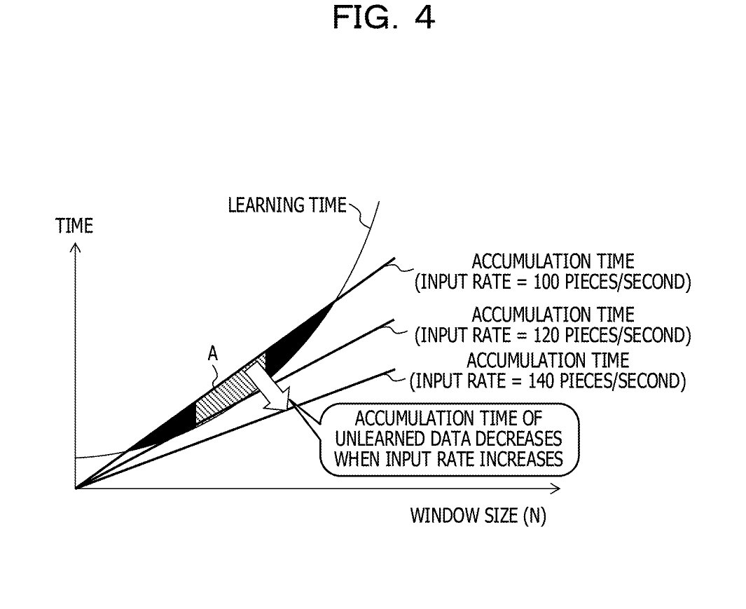

FIGS. 3 and 4 illustrate one example of relationship among a window size, a learning speed, and an input rate. As illustrated in FIG. 3, in a case where a window size N is too small with respect to the N pieces of new learning data, the learning speed becomes lower than the accumulation speed of input data (hereinafter, also referred to as “input rate”) due to the influence of the overhead of the incremental learning. In the algorithm in which the learning time is O((M+N)²), for example, the learning time does not exceed the data amount (M+N)², a too large window size N leads to the learning speed that is much lower than the input rate. Thus, the window size may be set within a range of N₁ to N₂ pieces that corresponds to an area A where the learning time does not exceed the accumulation time of input data even if the input rate somewhat fluctuates.

For example, as illustrated in FIG. 4, in a case where the input rate increases during execution of learning, the area A where the learning speed exceeds the input rate becomes small. In a case where the input rate is too large as the input rate 140 pieces/second in FIG. 4, the accumulation time of input data, for example, new unlearned data becomes short, and the learning speed becomes lower than the input rate for every window size. Thus, it may be difficult to set an appropriate window size.

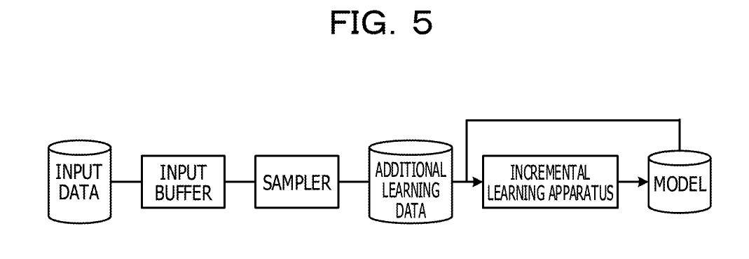

FIG. 5 illustrates one example of incremental learning. FIG. 5 illustrates the incremental type of machine learning, for example, the incremental learning version of the support vector machine algorithm. The incremental learning apparatus performs incremental learning from a large amount of time-series data that are mainly collected through a network.

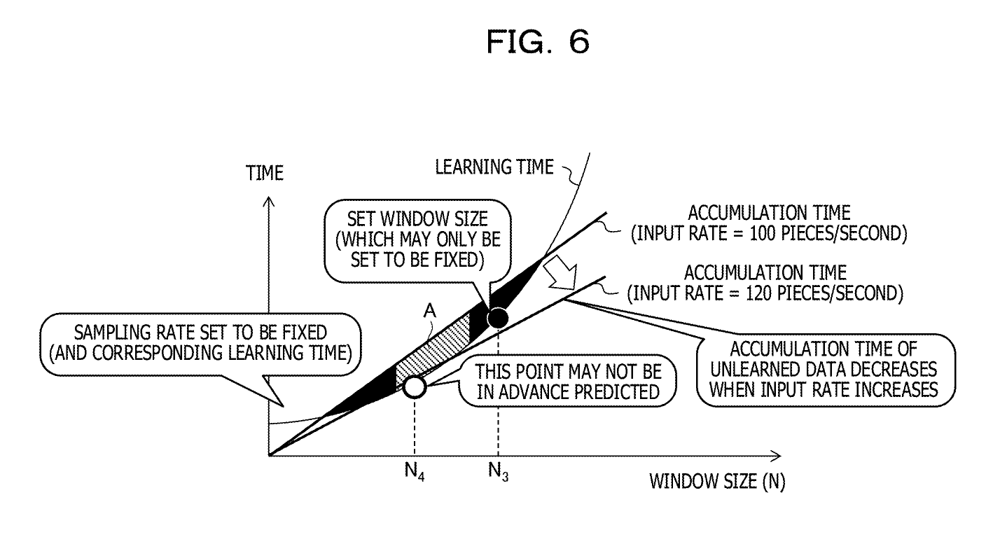

In the support vector machine algorithm, the window size, for example, the number of input data that are accumulated in the input buffer is a predetermined fixed value and does not dynamically fluctuate. The window size is fixed in incremental learning algorithms other than the support vector machine. For example, the fixed value of the window size is decided such that the learning speed becomes the same as or faster than the input rate. For example, in a case where the window size is N₃ pieces and the input rate is 100 pieces/second in FIG. 6, the learning time becomes shorter than the accumulation time of input data into the input buffer.

FIG. 6 illustrates one example of relationship between a learning speed and an input rate. FIG. 6 illustrates the relationship between the learning speed and the input rate in a case where the window size and sampling rate are fixed. For example, in a case where the input rate is increased from 100 pieces/second to 120 pieces/second as illustrated in FIG. 6 after the window size is decided, the learning speed may become slower than the input rate at the window size N₃. For example, in a case where the window size is N₃ and the input rate is 120 pieces/second in FIG. 6, the learning time becomes longer than the accumulation time of input data into the input buffer. In a case where the input rate fluctuates as described above, it may be difficult to in advance predict a window size N₄ at which the learning speed becomes equivalent to or lower than the input rate after a fluctuation.

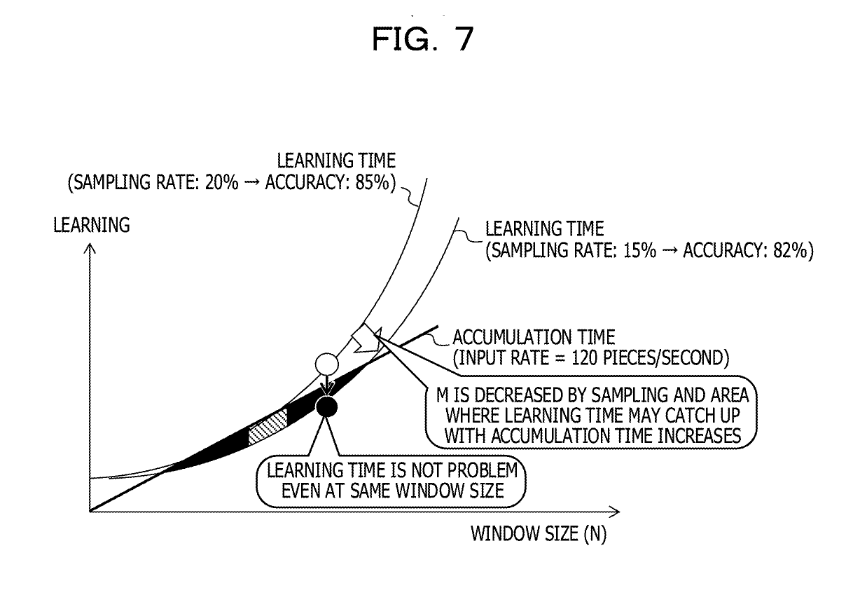

In a case where not all the data are learned but the data that are sampled in a specific ratio are learned, control is performed such that the time used for relearning by using M models becomes shorter, the learning speed becomes faster, and the learning time again becomes shorter than the accumulation time of input data. FIG. 7 illustrates one example of relationship among a sampling rate, a learning speed, and an input rate. For example, in a case where the sampling rate is reduced from 20% to 15% in FIG. 7, the learning speed becomes higher than the input rate at the same window size, and the learning time becomes shorter than the accumulation time of input data.

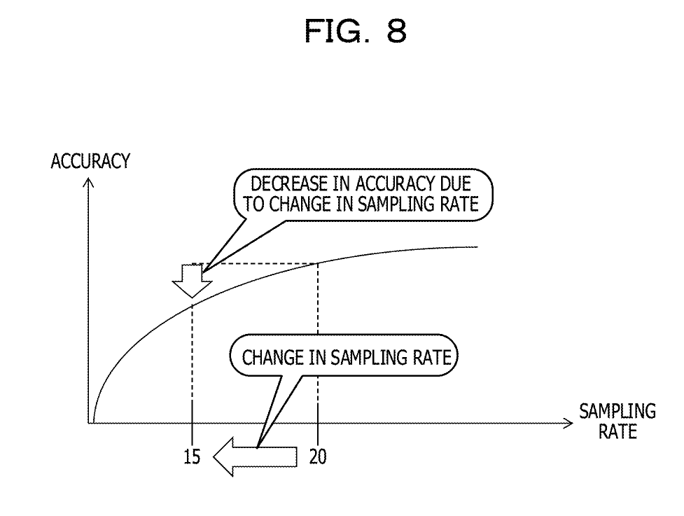

Because not all the input data are used for learning because of the sampling, the accuracy of a learning result may decrease. FIG. 8 illustrates one example of relationship between a change in a sampling rate and an accuracy. For example, in a case where the sampling rate is reduced from 20% to 15% in FIG. 8, the accuracy of the learning result decreases. In a case where the sampling rate is excessively reduced, the result of the incremental learning may not be maintained to appropriate accuracy. For example, as illustrated in FIG. 7, in a case where the sampling rate is reduced from 20% to 15%, the accuracy of the learning result decreases from 85% to 82%.

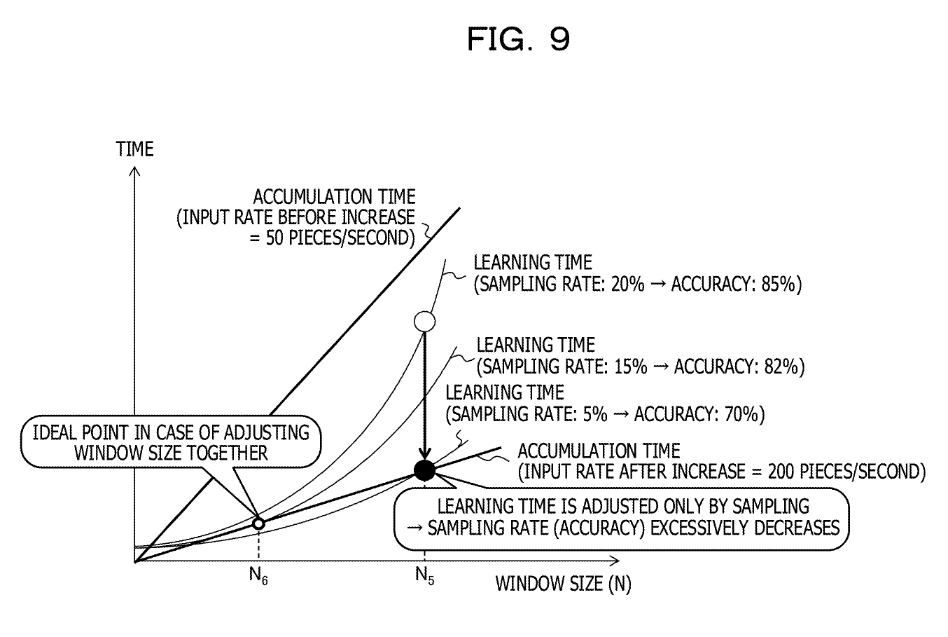

FIG. 9 illustrates one example of relationship between a change in a sampling rate and a window size. FIG. 9 illustrates an ideal point of the window size in a case where the sampling rate is changed. As illustrated in FIG. 9, a more appropriate window size N₆ may be set by reducing a decrease in the accuracy of the learning result by adjusting both of the sampling rate and the window size than by changing the sampling rate while the window size is fixed to N₅.

In the specification and drawings, the same reference characters are given to the elements that have substantially same or similar functional configurations, and descriptions thereof may not be repeated or reduced.

The machine learning includes three categories of learning methods, which are “batch learning”, “online learning”, and “incremental learning” illustrated in FIG. 1. The “batch learning” method exhibits very high accuracy but uses long learning time. With “batch learning”, relearning of all past data starts from scratch at each time when new data arise. Application of this learning method to real-time time-series data may be unrealistic.

In learning methods that are included in the category of “online learning” or “mini-batch learning”, a large amount of time-series data are learned almost in real time because learning is fast. However, those learning methods may exhibit low prediction accuracy about data that are not linearly separable.

In learning methods that are included in the category of “incremental learning”, almost equivalent accuracy to the batch learning is maintained, and learning is continued by using a previous result, without starting learning from scratch at each time when data arise. Thus, the learning time is shorter than the batch learning, and learning may be performed on time-series data almost in real time while high accuracy is retained.

As illustrated in FIG. 1, incremental learning exhibits higher accuracy than online learning unless the input rate exceeds a specific value (for example, several ten to several hundred pieces/second). For example, in order to obtain the learning result with high learning accuracy, an incremental learning management device may be provided, which variably sets the window size and the sampling rate of incremental learning within a restricting range of the learning time in accordance with the input rate.

Hereinafter, the window size is the number of input data that are used for one piece of learning and will be represented by “N”. The sampling rate is an extraction rate of sample data that are actually used for learning from the window size N and will be represented by “S”. The input rate is a data amount (data rate) that is input in one second and will be represented by “R”.

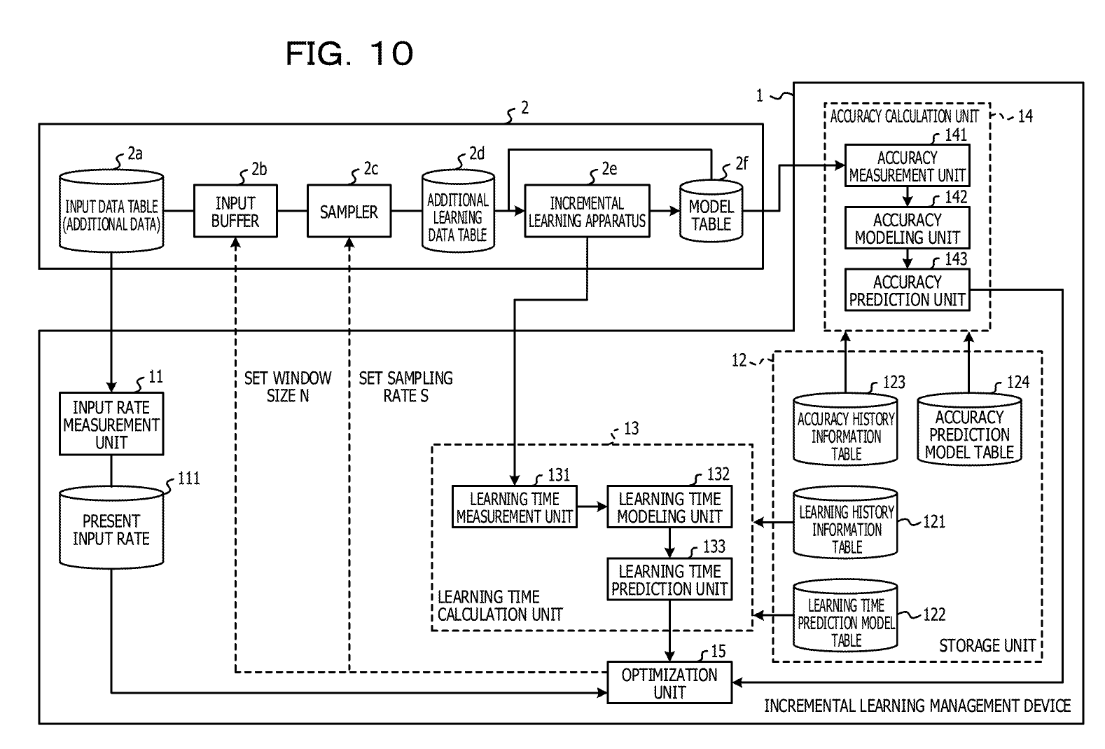

FIG. 10 illustrates one example of a configuration of an incremental learning management device. In an incremental learning device 2, an incremental learning apparatus 2e performs the incremental type of machine learning. In this case, data that are sequentially input in real time, for example, additional data are temporarily saved in an input data table 2a. N pieces of data that are set by the window size N among the additional data are accumulated in an input buffer 2b and thereafter input to a sampler 2c. The sampler 2c samples S % of the additional data that are input in accordance with a sampling rate S and saves the sampled data in an additional learning data table 2d.

The incremental learning apparatus 2e combines M pieces of model data, which are learning results so far obtained, with new and additional learning data and performs the incremental learning by using the combined data in accordance with an incremental learning algorithm. Models of M pieces of learned data are saved in a model table 2f.

For example, the incremental learning device 2 receives data transmitted from a terminal of a user who is provided with a certain service and models a behavioral pattern of the user by using those data. The result of the incremental learning is used for a purpose such as prediction of next behavior of the user. For example, in a case where the behavioral pattern of another user who has withdrawn from a certain service is similar to the modeled behavioral pattern of the user, the user is predicted to withdraw from the service with high probability. The result of the incremental learning may be used for some action to avoid withdrawal of the user or the like.

An incremental learning management device 1 is a device that manages the incremental learning device 2. The incremental learning management device 1 has an input rate measurement unit 11, a storage unit 12, a learning time calculation unit 13, an accuracy calculation unit 14, and optimization unit 15.

The input rate measurement unit 11 measures data that are input to the input data table 2a and received via the network or the like, for example, a flow rate (input rate or data rate) of additional data. The input rate measurement unit 11 counts how many pieces of data are received for one second, for example. The input rate measurement unit 11 may perform count for one minute or one hour in a case where the input rate is low.

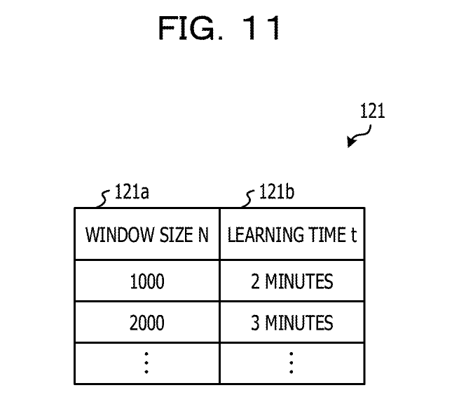

The storage unit 12 has a learning history information table 121, a learning time prediction model table 122, an accuracy history information table 123, and an accuracy prediction model table 124. FIG. 11 illustrates one example of a learning history information table. As illustrated in FIG. 11, the learning history information table 121 stores a window size (N) 121a and a learning time (t) 121b while associating those with each other. For example, the learning time 121b is 2 minutes when the window size (N) 121a is 1000, and the learning time 121b is 3 minutes when the window size (N) 121a is 2000. The window size and the learning time that are accumulated in the learning history information table 121 may be one example of learning history information.

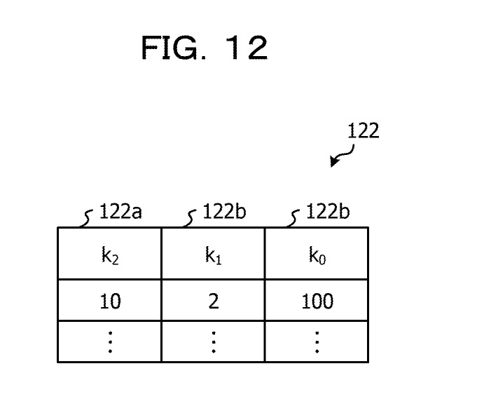

FIG. 12 illustrates one example of a learning time prediction model table. As illustrated in FIG. 12, the learning time prediction model table 122 illustrates the structure of a learning time prediction model. For example, in a case where a non-linear regression analysis (hereinafter, also referred to as “polynomial regression”), in which the polynomial model is used, is applied to modeling of the learning time, coefficients that are obtained as a result of the polynomial regression analysis are stored in the learning time prediction model table 122. In FIG. 12, a coefficient (k₂) 122a, a coefficient (k₁) 122b, and a coefficient (k₀) 122c that are obtained as a result of the polynomial regression analysis are stored. The coefficients stored in the learning time prediction model table 122 are used to calculate a model represented by a learning time function T(N, S)=k₂(N·S)²+k₁(N·S)+k₀. N·S is the number of new additional data that are learned by the incremental learning apparatus 2e.

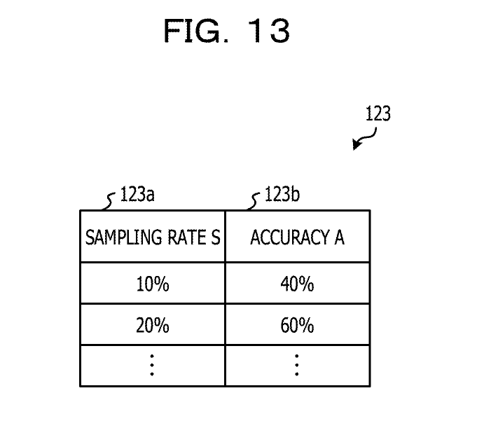

FIG. 13 illustrates one example of an accuracy history information table. As illustrated in FIG. 13, the accuracy history information table 123 stores a sampling rate (S) 123a and accuracy (A) 123b while associating those with each other. For example, the accuracy (A) 123b is 40% when the sampling rate (S) 123a is 10%, and the accuracy (A) 123b is 60% when the sampling rate (S) 123a is 20%.

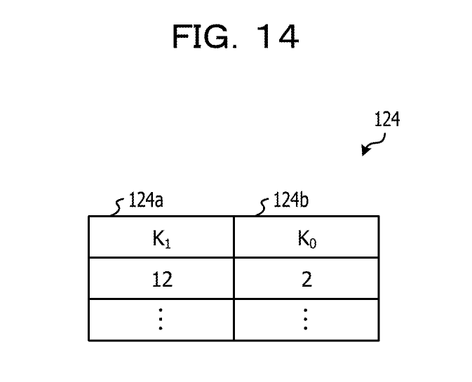

FIG. 14 illustrates one example of an accuracy prediction model table. As one example is illustrated in FIG. 14, the accuracy prediction model table 124 illustrates the structure of an accuracy prediction model. For example, in a case where a non-linear regression analysis (hereinafter, also referred to as “logarithm regression”), in which the logarithm model is used, is applied to modeling of the accuracy, coefficients that are obtained as a result of the logarithm regression analysis are stored. In FIG. 14, a coefficient (K₁) 124a and a coefficient (K₀) 124b that are obtained as a result of the logarithm regression analysis are stored.

The learning time calculation unit 13 has a learning time measurement unit 131, a learning time modeling unit 132, and a learning time prediction unit 133.

The learning time measurement unit 131 receives new data for next incremental learning, for example, additional data from the input buffer 2b and measures learning time t by recording the times when the incremental learning starts and finishes. The measured learning time t is stored in the learning history information table 121 while being associated with the window size N that is set at the point in time. The learning time measurement unit 131 calculates the learning time at each time when N pieces of data are learned by the incremental learning apparatus 2e.

The learning time modeling unit 132 extracts all the learning times and data amounts of the learning performed in the past from the learning history information table 121 and performs regression processing based on those pieces of information. When the regression processing finishes, the learning time modeling unit 132 records coefficients that are obtained as a result of the regression processing in the learning time prediction model table 122. The regression processing may not necessarily be executed by extracting all the learning times and data amounts of the learning performed in the past but may be executed based on portions of the leaning times and the data amounts of the learning performed in the past, for example.

A regression operation may employ regression techniques such as linear regression, polynomial regression, or non-parametric regression, for example. The regression technique to be used may be decided by the user. In a case where polynomial regression is used, it is assumed that the learning time function T(N, S) to be modeled is in a form such as the function T(N, S)=k₂(N·S)²+k₁(N·S)+k₀, for example. The coefficient k₂, coefficient k₁, and coefficient k₀ are defined in a regressive manner based on the learning times that are stored in the learning history information table 121 in the past. N×S is an amount of data that is newly added to the incremental learning apparatus 2e.

Modeling of the learning time may be effective in a case where the form of the learning time is in advance known to some extent. A method of non-parametric regression may be used in a case where the form of the learning time is not known in advance. Non-parametric regression may include Gaussian process regression, for example.

The learning time prediction unit 133 predicts the learning time in accordance with the regression technique that is used for modeling the learning time and designated by the user or set in advance. For example, in a case where polynomial regression is used for modeling the learning time, the coefficients that are obtained as a result of the polynomial regression (for example, k₂, k₁, and k₀) are used to calculate the learning time function T(N, S)=k₂(N·S)²+k₁(N·S)+k₀. Accordingly, a prediction value T of the learning time is calculated.

The accuracy calculation unit 14 has an accuracy measurement unit 141, an accuracy modeling unit 142, and an accuracy prediction unit 143. The accuracy measurement unit 141 receives model data (input data) that the incremental learning device 2 obtains by the incremental learning and measures the accuracy of the learning result with the set sampling rate S. The accuracy may be calculated by a function A(S) that models the accuracy, for example. The accuracy measurement unit 141 may acquire test data instead of the model data. Measured accuracy P is stored in the accuracy history information table 123.

The accuracy modeling unit 142 performs regression processing based on the accuracy prediction model table 124. In a case where logarithm regression is used, it is assumed that an accuracy function P(S: sampling rate) to be modeled is in a form such as A(S)=k₀+k₁ log(N·S), for example, and the accuracy is modeled.

The accuracy prediction unit 143 predicts the accuracy in accordance with the regression technique that is used for modeling the accuracy and designated by the user or set in advance.

The learning time calculation unit 13 and the accuracy calculation unit 14 may be examples of a calculation unit that calculates (optimizes) the window size N and the sampling rate S based on the measured data rate, the learning history information, and the present sampling rate S.

The optimization unit 15 optimizes the window size N and the sampling rate S based on the accuracy in accordance with the sampling rate S. Thus, the number of data of the additional data that are accumulated in the input buffer 2b is variably controlled to an appropriate value based on the optimized window size N. The number of sampled data that are output from the sampler 2c to the incremental learning apparatus 2e is variably controlled to an appropriate value based on the optimized sampling rate S.

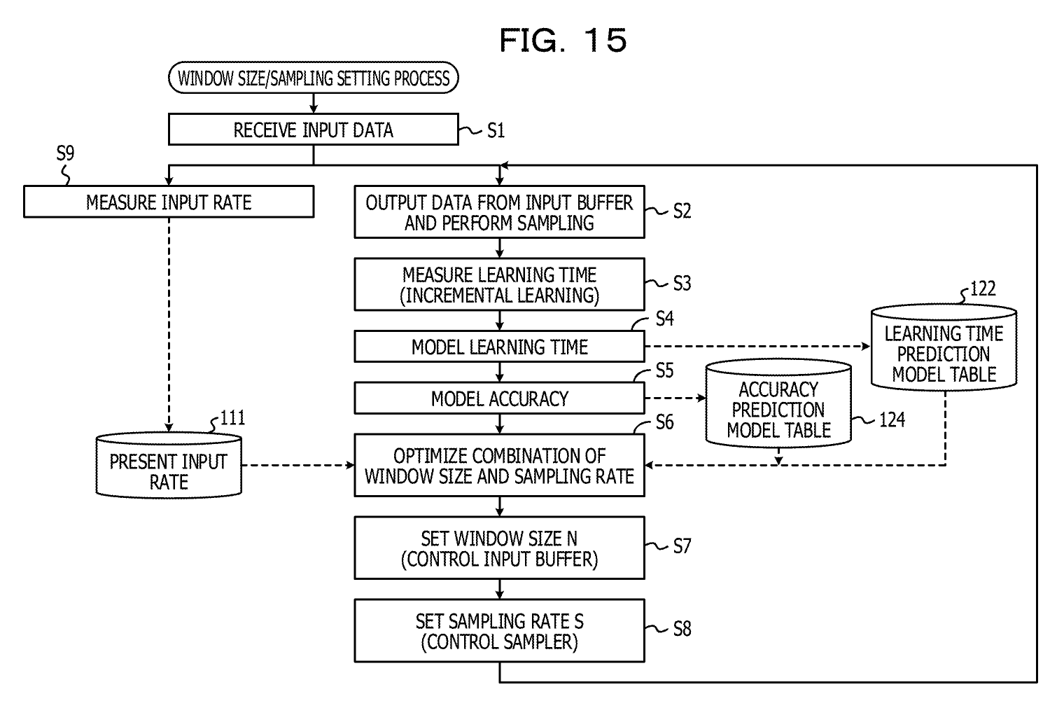

FIG. 15 illustrates one example of a window size/sampling rate (N/S) setting process.

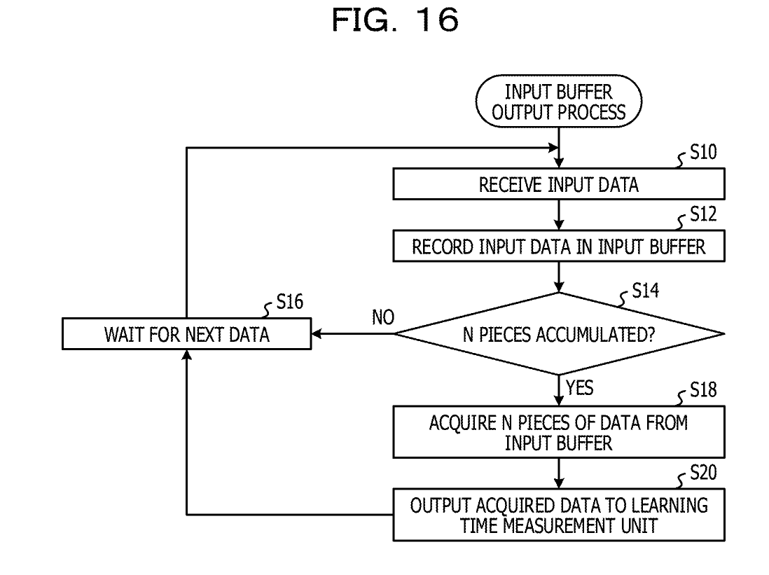

When the process starts, the input data are received (operation S1) and accumulated in the input buffer 2b. When N pieces of data of the window size are accumulated in the input buffer 2b, N pieces of data are output from the input buffer 2b, and the output data are sampled by the sampler 2c (operation S2). FIG. 16 illustrates an output process from the input buffer.

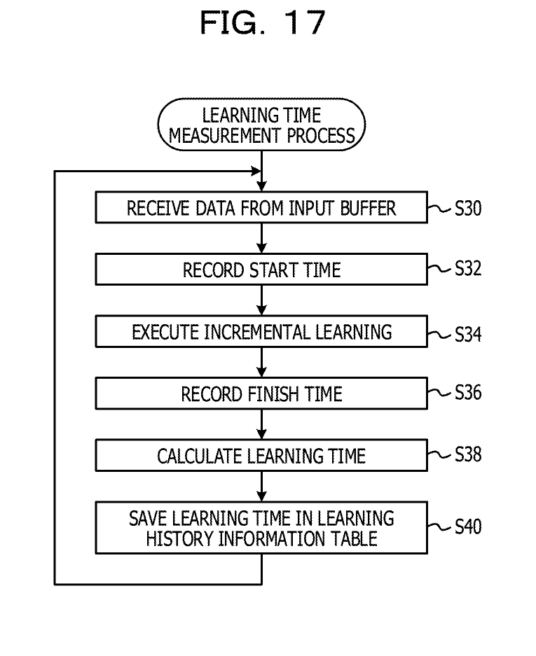

The learning time calculation unit 13 acquires N×S pieces of output data that are sampled by the sampler 2c and measures the learning time of the incremental learning apparatus 2e (operation S3). FIG. 17 illustrates a measurement process of the learning time.

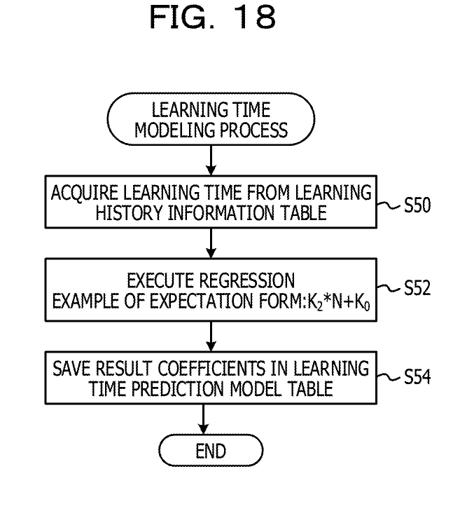

The learning time calculation unit 13 calculates the learning time in accordance with the set regression technique by using the coefficients of the regression equation, which are calculated by the regression processing, based on the learning time prediction model table 122 (operation S4). FIG. 18 illustrates a modeling process of the learning time.

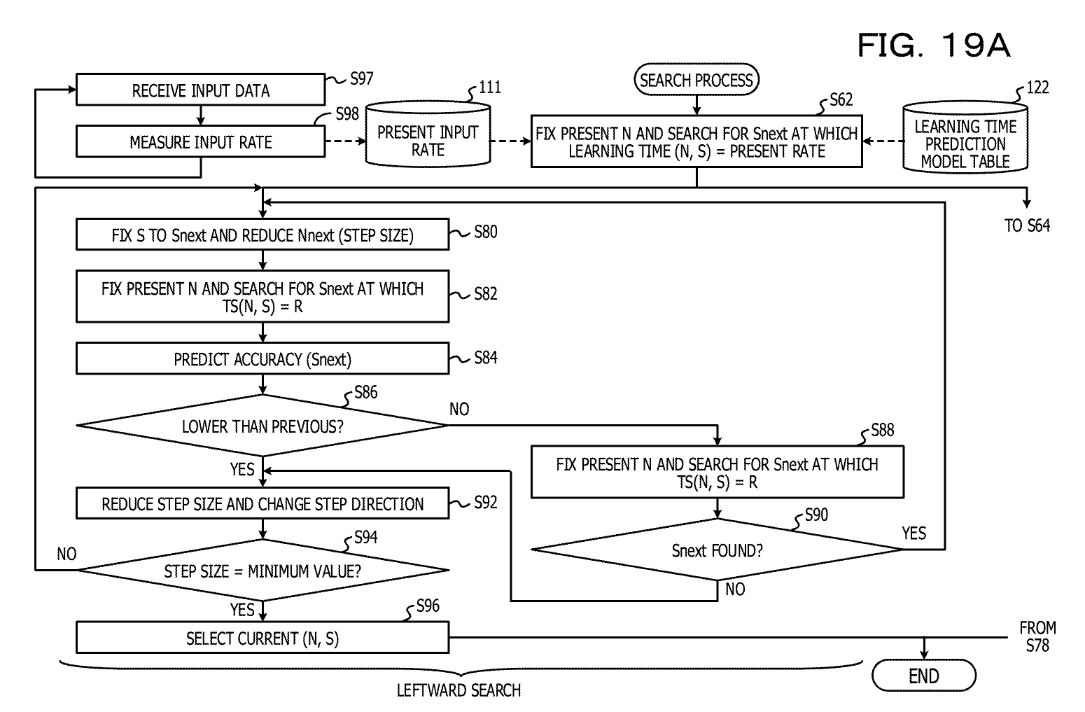

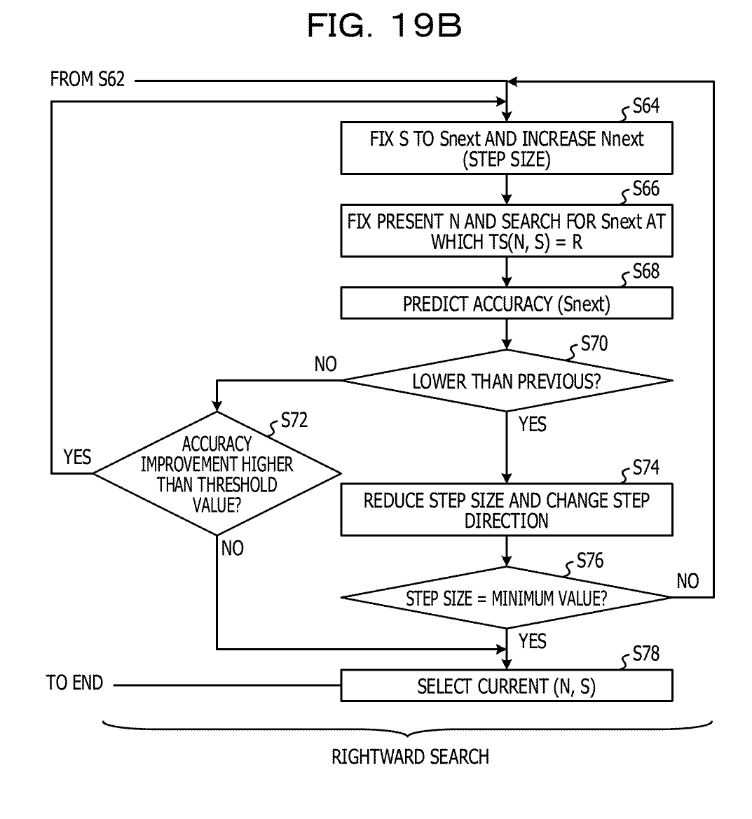

The accuracy calculation unit 14 calculates the accuracy in accordance with the set regression technique by using the coefficients of the regression equation based on the accuracy prediction model table 124 (operation S5). FIGS. 19A to 22C illustrate a search process of (N, S) by the learning time calculation unit 13 and the accuracy calculation unit 14.

The optimization unit 15 optimizes the window size N and the sampling rate S based on the input rate 111 in this point in time, the learning time prediction model table 122, and the accuracy prediction model table 124 (operation S6). The optimization unit 15 sets the window size N and the optimized window size N based on accuracy A and controls the input buffer 2b (operation S7). The optimization unit 15 sets the optimized sampling rate S and controls the sampler 2c (operation S8). The process returns to operation S2 and repeats operations S2 to S8. FIG. 16 illustrates one example of an input buffer output process. When the input data are received (operation S10), the incremental learning device 2 records the input data in the input buffer 2b (operation S12). The incremental learning device 2 determines whether the N pieces of data that are defined by the window size are saved in the input buffer 2b (operation S14). In a case where a determination is made that the N pieces of data are not saved in the input buffer 2b, the incremental learning device 2 waits for next input data (operation S16) and repeats operations S10 to S16 until the N pieces of data are saved in the input buffer 2b.

In a case where it is determined that the N pieces of data are saved in the input buffer 2b, the incremental learning apparatus 2e acquires data that are output from the input buffer 2b and extracted by the sampler 2c (operation S18) and outputs the acquired data to the learning time measurement unit 131 (operation S20). The input buffer 2b thereafter waits for next input data (operation S16) and repeats operations S10 to S20 when new input data are received (operation S10). The incremental learning is performed at each time when N pieces of data are accumulated in the input buffer 2b. The learning history information that corresponds to the incremental learning is accumulated in the learning history information table 121 by a next learning time measurement process. FIG. 17 illustrates one example of the learning time measurement process. The process illustrated in FIG. 17 may be executed after the input buffer output process is finished. The learning time measurement unit 131 acquires the input data from the input buffer 2b (operation S30). The learning time measurement unit 131 records the time when the incremental learning by the incremental learning apparatus 2e between the input data and the model starts (start time) (operation S32). The learning time measurement unit 131 executes the incremental learning (operation S34). The learning time measurement unit 131 records the time when the incremental learning finishes (finish time) by the incremental learning apparatus 2e (operation S36). The learning time measurement unit 131 calculates the difference between the finish time and the start time as the learning time (operation S38). The learning time measurement unit 131 records the calculated learning time in the learning history information table 121 (operation S40). FIG. 18 illustrates one example of a learning time modeling process. The process illustrated in FIG. 18 may be executed after the learning time measurement process is finished. The learning time modeling unit 132 acquires the learning times from the learning history information table 121 (operation S50).

The learning time modeling unit 132 performs regression processing based on the acquired learning times (operation S52). When the regression processing finishes, the learning time modeling unit 132 records coefficients that are obtained as a result of the regression processing in the learning time prediction model table 122 (operation S54) and finishes the process. A search for the window size N and the sampling rate S is performed. Each time when the model of the learning time is updated or the input rate is changed largely (in a specific or higher ratio), the window size N and the sampling rate S are again set, and the combination of the window size N and the sampling rate S is optimized.

A method of obtaining the optimal combination (N, S) may include the derivative equation of the learning time function and the hill climbing method. The derivative equation of the learning time function exhibits fast processing time but may not be applicable due to low versatility. In a case where polynomial regression is used for modeling the learning time, the derivative equation of the learning time function is used. The hill climbing method exhibits slow processing time but is applied to any case because of high versatility. The hill climbing method is used in a case where non-parametric regression is used for modeling the learning time.

The optimization by using the derivative equation of the learning time function is applied in a case where the combinations of (N, S), which allows the learning speed to be equivalent to the input rate, may be used for formulation of a function such as S=F(N), formulation of a derivative function ds(N)/dN of the function S=F(N), and formulation of Nmax(K) where ds(N)/dN=0. K represents the model obtained by modeling the learning time. For example, in a case of a quadratic polynomial, K={k₀, k₁, k₂} is obtained.

Nmax(k₂, k₀) and Smax(k₂, k₀) are in advance formulated, the coefficients k₂ and k₀ that are obtained by modeling the learning time during execution are acquired from the learning time prediction model table 122, and Nmax and Smax are directly obtained.

For example, a model equation (A) that is expressed by a function T(N, S)=k₂(N·S)²+k₀ is used for the learning time, and a model equation (B) that is expressed by A(S)=k₀+k₁ log(N·S) is used for the accuracy.

For example, the hill climbing method (subgradient method) is used to select the optimal values of the window size N and the sampling rate S. In the optimization of two parameters (window size N and sampling rate S) by using the hill climbing method, the combination with the highest accuracy A(S) is selected from multiple combinations of (N, S) in which a learning speed TS(N, S) is the same as or approximates an input rate R.

FIGS. 19A and 19B illustrate one example of a search process. The search process illustrated in FIGS. 19A and 19B may be executed after the learning time modeling process and the accuracy modeling process are finished and uses a modeled learning time T and the modeled accuracy A.

For example, as the modeled learning time T, the model equation that is expressed by the function T(N, S)=k₂(N·S)²+k₀ is used. As the modeled accuracy A, the model that is expressed by the function A(S)=k₀+k₁ log(N·S) is used.

The modeling of the learning time T and the accuracy A is not limited to the above modeling. The learning time T(N, S) may be modeled by using a method of polynomial regression or linear interpolation, for example.

The learning time calculation unit 13 fixes the window size N at this point in time and searches for a sampling rate Snext that allows the learning speed TS(N, S) to be equivalent to the input rate R at this point in time (operation S62).

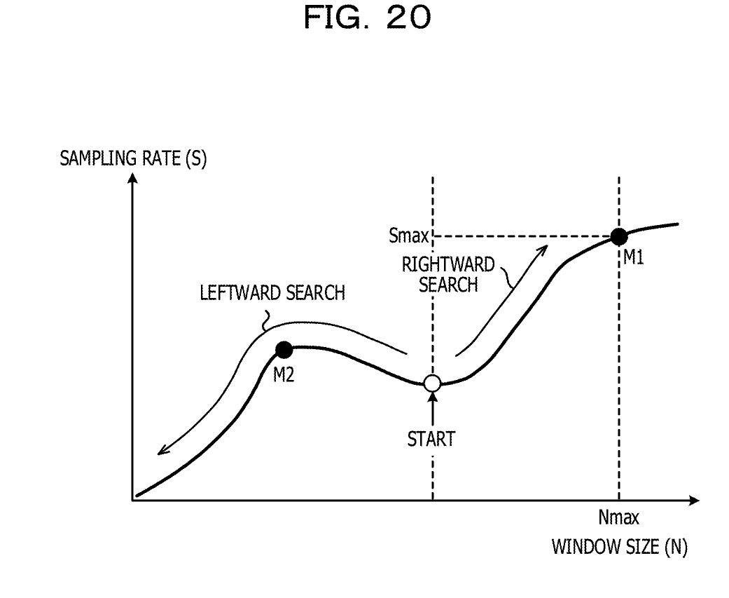

FIG. 20 illustrates examples of a rightward search and a leftward search of an N/S search process. In an operation group (S64 to S78) that branches to the right from operation S62 in FIG. 19A, the process progresses rightward from a start illustrated in FIG. 20, and the window size N and the sampling rate S are searched for by using the hill climbing method and in accordance with the model of the learning time T(N, S). In an operation group (S80 to S96) that branches to the left from operation S62 in FIG. 19A, the process progresses leftward from the start illustrated in FIG. 20, and the window size N and the sampling rate S are searched for similarly by using the hill climbing method and in accordance with the model of the learning time T(N, S) that are in advance defined.

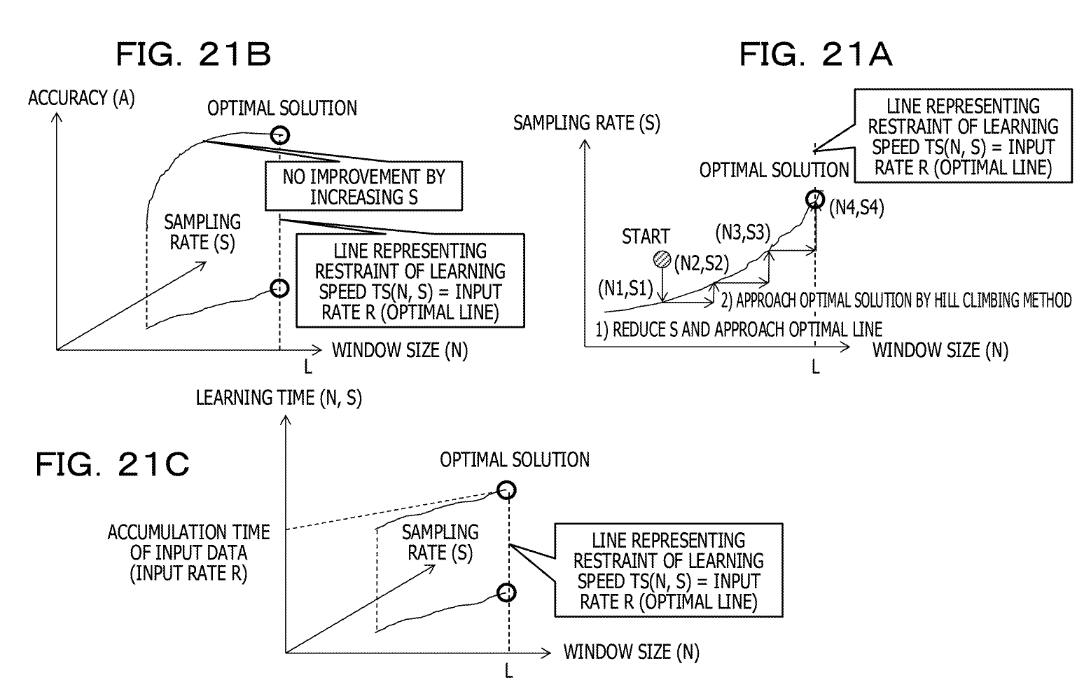

FIGS. 21A to 21C illustrate one example of an N/S rightward search process. A rightward search for the window size N and the sampling rate S is executed. The learning time calculation unit 13 fixes the window size N in operation S62 and searches for the sampling rate Snext at which the learning speed TS(N, S) becomes the input rate R in this point in time. As a result, as illustrated in (1) in FIG. 21A, the sampling rate S is changed without changing the window size N from a start point, and a point (N1, S1) is selected from the model of the learning time T(N, S). Here, the point (N1, S1) within the range of the condition (optimal line) where the learning speed TS(N, S) becomes the value of the input rate R at this point in time or lower is selected.

The learning time calculation unit 13 increases the window size N without changing the sampling rate Snext and searches for the sampling rate S in accordance with the model of the learning time T(N, S), and searches for a window size Nnext (N2 in FIG. 21A) (operation S64). At this point in time, the difference between N1 and N2 becomes a step size of the rightward search.

The learning time calculation unit 13 fixes the window size N at this point in time and searches for the sampling rate Snext that allows the learning speed TS(N, S) to be equivalent to the input rate R at this point in time (operation S66). As a result, as illustrated in (2) in FIG. 21A, the sampling rate S is changed without changing the window size N2, and a point (N2, S2) that is reached in accordance with the model of the learning time T(N, S) is identified.

The accuracy calculation unit 14 predicts accuracy A(Snext) in accordance with the model of the accuracy A(S), which is in advance defined, based on the sampling rate Snext at this point in time (operation S68). The accuracy calculation unit 14 determines whether the accuracy A is lower than the previous accuracy (operation S70). In a case where the accuracy calculation unit 14 determines that the accuracy A is not lower than the previous accuracy, the accuracy calculation unit 14 determines whether an accuracy improvement (the difference from the previous accuracy) is higher than a threshold (operation S72). In a case where the accuracy calculation unit 14 determines that the accuracy improvement is higher than the threshold, the accuracy calculation unit 14 determines that the accuracy is improved. The process returns to operation S64, and the process of operation S64 and subsequent operations is repeated.

In a case where the accuracy calculation unit 14 determines that the accuracy A is not lower than the previous accuracy (operation S70) and the accuracy improvement is equivalent to or lower than the threshold (operation S72), the accuracy calculation unit 14 determines that a further search probably does not lead to an accuracy improvement and selects the combination of (N, S) at this point in time as the optimal values (operation S78).

In operation S70, in a case where the accuracy calculation unit 14 determines that the accuracy A is lower than the previous accuracy, the accuracy calculation unit 14 determines that the search is in a lower point than the vertex (inflection point) of the model of the learning time T(N, S), reduces the step size, and changes a step direction (the direction of search) to the opposite direction (operation S74). The learning time calculation unit 13 determines whether the step size at this point in time is equivalent to a minimum value that is in advance defined (operation S76). In a case where the learning time calculation unit 13 determines that the step size at this point in time is different from the minimum value, the process returns to operation S64 and repeats operation S64 and subsequent operations.

In a case where the learning time calculation unit 13 determines that the step size at this point in time is equivalent to the minimum value, the learning time calculation unit 13 determines that the optimal values of the window size N and the sampling rate S are obtained and selects the combination of (N, S) at this point in time as the optimal values (operation S78). The rightward search process finishes.

As indicated by “optimal solution” in FIG. 21A, the optimal values (N4, S4) of the window size N and the sampling rate S on the optimal line that represents restraint which provide the learning speed TS(N, S) equivalent to or lower than the input rate R are calculated.

As indicated by “optimal solution” in FIG. 21B, the optimal values of the combination of (N, S) are calculated. In addition, in a case where an improvement in the accuracy A is not found at a certain point even if the sampling rate S is increased, the process is terminated, and a redundant search process may not be repeated.

As indicated by “optimal solution” in FIG. 21C, the optimal values of the window size N and the sampling rate S are obtained under restraint which provide the learning speed TS(N, S) equivalent to or lower than the input rate R.

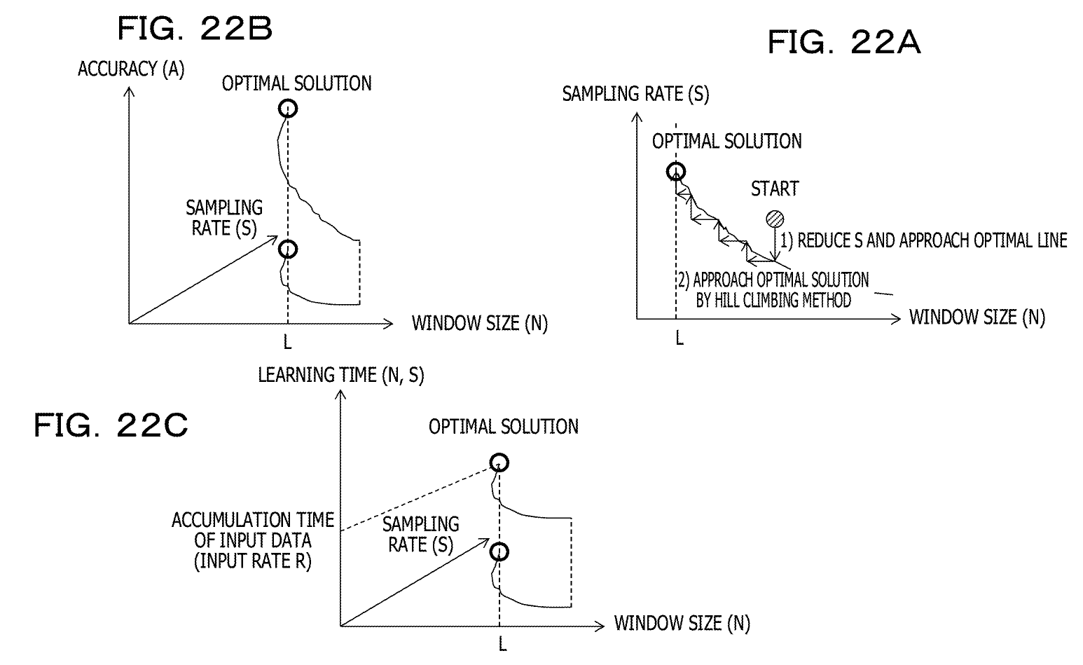

FIGS. 22A to 22C illustrate one example of an N/S leftward search process. A leftward search for the window size N and the sampling rate S is executed with an operation group that branches to the left from operation S62. The learning time calculation unit 13 fixes the window size N in operation S62 and searches for the sampling rate Snext at which the learning speed TS(N, S) becomes the input rate R in this point in time. As a result, as illustrated in (1) in FIG. 22A, the sampling rate S is changed without changing the window size N from a start point, and the point that is reached in accordance with the model of the learning time T(N, S) is selected. Here, a point within the range of the condition (optimal line) where the learning speed TS(N, S) becomes the value of the input rate R at this point in time or lower is selected.

The learning time calculation unit 13 reduces the window size N without changing the sampling rate Snext and searches for the sampling rate S in accordance with the model of the learning time T(N, S), and searches for the window size Nnext (operation S80). Accordingly, the step size of the leftward search is defined.

The learning time calculation unit 13 fixes the window size N at this point in time and searches for the sampling rate Snext that allows the learning speed TS(N, S) to be equivalent to the input rate R at this point in time (operation S82). As a result, as illustrated in (2) in FIG. 22A, the sampling rate S is changed without changing the window size N, and the point that is reached in accordance with the model of the learning time T(N, S) is identified.

The learning time calculation unit 13 predicts the accuracy A(Snext) in accordance with the model of the accuracy A(S), which is in advance defined, based on the sampling rate Snext at this point in time (operation S84). The accuracy calculation unit 14 determines whether the accuracy A is lower than the previous accuracy (operation S86). In a case where the accuracy calculation unit 14 determines that the accuracy A is not lower than the previous accuracy, the accuracy calculation unit 14 fixes the window size N at this point in time and searches for the sampling rate Snext that allows the learning speed TS(N, S) to be equivalent to the input rate R at this point in time (operation S88). In a case where the sampling rate Snext is found as a result (operation S90: “Yes”), the process returns to operation S80 and repeats operation S80 and subsequent operations.

In a case where the sampling rate Snext is not found in operation S88 (operation S90: “No”) or a determination is made that the accuracy A is lower than the previous accuracy in operation S86, the accuracy calculation unit 14 reduces the step size and changes the step direction (the direction of search) to the opposite direction (operation S92).

The learning time calculation unit 13 determines whether the step size at this point in time is equivalent to the minimum value that is in advance defined (operation S94). In a case where the learning time calculation unit 13 determines that the step size at this point in time is different from the minimum value, the process returns to operation S80, and the process of operation S80 and subsequent operations is repeated.

In a case where the learning time calculation unit 13 determines that the step size at this point in time is equivalent to the minimum value, the learning time calculation unit 13 determines that the optimal values of the window size N and the sampling rate S are obtained and selects the combination of (N, S) at this point in time as the optimal values (operation S96). The leftward search process finishes.

As indicated by “optimal solution” in FIG. 22A, the optimal values of the window size N and the sampling rate S on the optimal line that represents restraint which provide the learning speed TS(N, S) equivalent to or lower than the input rate R are calculated. This provides a state where an optimal value M1 obtained by the rightward search and an optimal value M2 obtained by the leftward search, which are illustrated in FIG. 20, are selected.

In a case where the learning time is in a form such as T(N)=log(N), only a slight accuracy improvement may be achieved regardless of how much the sampling rate S is increased. On the other hand, in the above search method, as described about operation S72, in a case where the probable accuracy improvement is smaller than a specific threshold, continuation of the process by further increasing the sampling rate S is avoided, and the window size N and sampling rate S at this point in time are set as the optimal values.

For example, the higher the sampling rate S becomes, the more the accuracy A(S) increases. For example, depending on the circumstances, it is not preferable to unconditionally make the sampling rate S higher. For example, in a case where the learning time is a function such as T(N)=log(N), the learning speed TS(N, S) becomes equivalent to the input rate R if N is increased in response to the increase in S even if S is unconditionally increased. Because the learning time for one difference also increases, freshness of the model may be lost.

As for the accuracy such as A(S)=log(S) also, the more the sampling rate S increases, the smaller the improvement in the accuracy A(S) becomes. Thus, in a case where the sampling rate S exceeds a specific sampling rate, increasing the sampling rate S may result in little effect. Thus, selection of (N, S) from which an improvement in the accuracy A(S) is expected, that is, selection of the optimal values of the window size N and the sampling rate S may be performed.

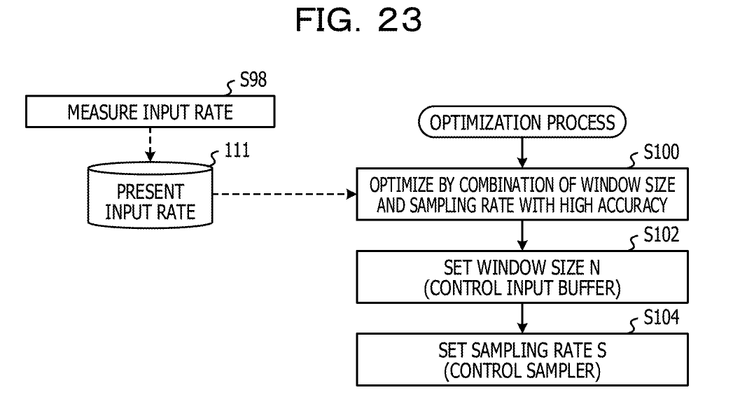

FIG. 23 illustrates one example of an optimization control process.

When the process illustrated in FIG. 23 is started, the optimization unit 15 sets the combination of the optimal values (Nmax, Smax) of the window size N and the sampling rate S based on the present input rate R (operation S100). The optimization unit 15 sets the optimal values with the higher accuracy A between the optimal values obtained as a result of the rightward search and the optimal values obtained as a result of the leftward search in FIGS. 19A and 19B as the optimal value Nmax of the window size N and the optimal value Smax of the sampling rate S at this point in time.

The optimization unit 15 may control the incremental learning device 2 by using either one of two optimal values of the window size N and the sampling rate S, for example, either one of the optimal values M1 and M2 in FIG. 20.

The optimization unit 15 changes the window size N of the input buffer 2b to the set window size Nmax (operation S102) and increases or reduces the data amount that is retained in the input buffer 2b.

The optimization unit 15 changes the sampling rate S of the sampler 2c to the set sampling rate Smax (operation S104) and increases or reduces the data amount that the sampler 2c samples from the data output from the input buffer 2b.

In the incremental learning management device 1, the combination (N, S) of the optimal window size N and sampling rate S is selected based on prediction of the input rate R and the learning time T. For example, the processing speed of the incremental learning is increased by reducing the sampling rate S, the window size N is also changed, and the combination with the highest accuracy A of learning is thereby found.

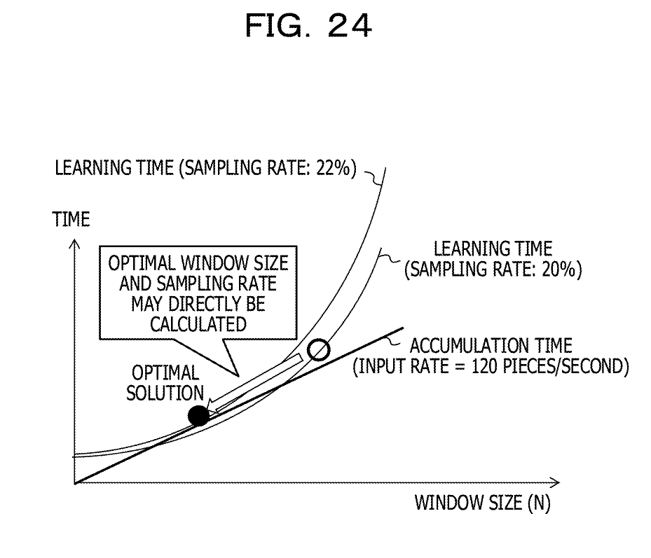

In the incremental learning, the window size N and the sampling rate S are variably set within the restriction range of the learning time T in accordance with the input rate R, for example, the range where the learning time T does not exceed the accumulation time of input data into the input buffer 2b. FIG. 24 illustrates one example of optimized N/S. As illustrated in FIG. 24, the window size N and the sampling rate S are adjusted to appropriate values while taking into account the balance between the accuracy and the learning time, and the result of the incremental learning with high accuracy may thereby be obtained. Optimization methods of the window size N and the sampling rate S include methods that use equations which are in advance formulated and methods that use a general-purpose solver. For example, in the former methods, formulation of Nmax and Smax in a case of using polynomial regression may be performed. For example, the above optimization method of the window size N and the sampling rate S may be one example. For example, the model equation (A) of the learning time T and the model equation (B) of the accuracy A may be examples of methods of calculating factors. For example, the following equations (1) and (2) are used, and the maximum value Nmax of the window size and the maximum value Smax of the sampling rate may thereby be directly calculated based on k₂ and k₀. Although the form is other than a learning time T(N′)=k₂(N′)²+k₀, Nmax and Smax are similarly formulated, and direct calculation may thereby be performed.

Learning time:TT(N,S)=k₂(M+S·N)²+k₀(M is a model size)

k₂ and k₀ are calculated from the polynomial equation in the following form during execution.

T(N′)=k₂(N′)²+k₀(N′=M+S×N)

Learning speed:TS(N,S)=N/T(N,S)

During execution, for example, at each time when the input rate R changes, the combination (Nmax, Smax) of the optimal window size and sampling rate that maximizes the accuracy among the combinations of (N, S) that allow the learning speed TS(N, S) to be equivalent to the input rate R is obtained as follows.

A function of the accuracy A=F(N, k₂, k₀) is extracted in advance (before execution) from the conditions where the learning speed TS(N, S) becomes equivalent to the input rate R. The derivative function S′(N, k₂, k₀)=ds(N, k₂, k₀)/dN of S(N, k₂, k₀) is obtained. The function of Nmax(k₂, k₀) that allows S′(N, k₂, k₀) to become zero is obtained in advance (before execution), and thereby the optimal value Nmax of N is simply calculated by using k₂ and k₀ that are decided by the regression processing during execution.

For example, the function of S(N, k₂, k₀) is extracted in advance (before execution) from the conditions where learning speed TS(N, S)=input rate R, as follows. For example, equation (3) may be obtained based on the following equation (1) and equation (2). The function of S(N, k₂, k₀) expressed by equation (4) may be obtained based on equation (3).

$$\begin{matrix}T ( N , S ) = {{k}_{2} ( M + S \cdot N )}^{2} + {k}_{0} & ( 1 ) \\ TS ( N , S ) = \frac{N}{T ( N , S )} = R ⇔ T ( N , S ) = \frac{N}{R} & ( 2 ) \\ {{k}_{2} ( M + S \cdot N )}^{2} + {k}_{0} = \frac{N}{R} & ( 3 ) \\ S ( N , {k}_{2} , {k}_{0} ) = \frac{\sqrt{N - R \cdot {k}_{0}}}{\sqrt{R \cdot {k}_{2}} \cdot N} - \frac{M}{N} & ( 4 )\end{matrix}$$

The following equation (5) may be obtained by calculating the derivative function S′(N, k₂, k₀)=ds(N, k₂, k₀)/dN of S(N). As expressed by equation (6), the function of Nmax(k₂, k₀) that allows the derivative function S′(N, k₂, k₀) to become zero is obtained in advance (before execution) based on equation (5) and equation (6). Accordingly, as expressed by equation (7), the function of Nmax(k₂, k₀) that allows the derivative function S′(N, k₂, k₀) to become zero may be obtained. The optimal value Nmax(k₂, k₀) of the window size N is calculated based on k₂ and k₀ that are decided by the regression processing during execution.

$$\begin{matrix} \frac{d S ( N , {k}_{2} , {k}_{0} )}{d N} = \frac{- N + 2 {Rk}_{0} + 2 M \sqrt{{Rk}_{2}} \sqrt{N - {Rk}_{0}}}{2 \sqrt{{Rk}_{2}} \sqrt{N - {Rk}_{0}} {N}_{2}} & ( 5 ) \\ \frac{d S ( N , {k}_{2} , {k}_{0} )}{d N} = 0 & ( 6 ) \\ {N}_{max} ( {k}_{2} , {k}_{0} ) = - 2 {Rk}_{0} - 2 {Rk}_{2} {M}^{2} ∓ \sqrt{\frac{{( 4 {Rk}_{0} + 4 {Rk}_{2} {M}^{2} )}^{2}}{4} - ( 4 {R}^{2} {k}_{0}^{2} + 4 {R}^{2} {k}_{0} {k}_{2} {M}^{2} )} & ( 7 )\end{matrix}$$

The optimal value Nmax(k₂, k₀) calculated based on equation (7) is substituted into equation (8), and the optimal value Smax(k₂, k₀) of the sampling rate S is thereby calculated.

Sₘₐₓ(k₂,k₀)=S(Nₘₐₓ(k₂,k₀)) (8)

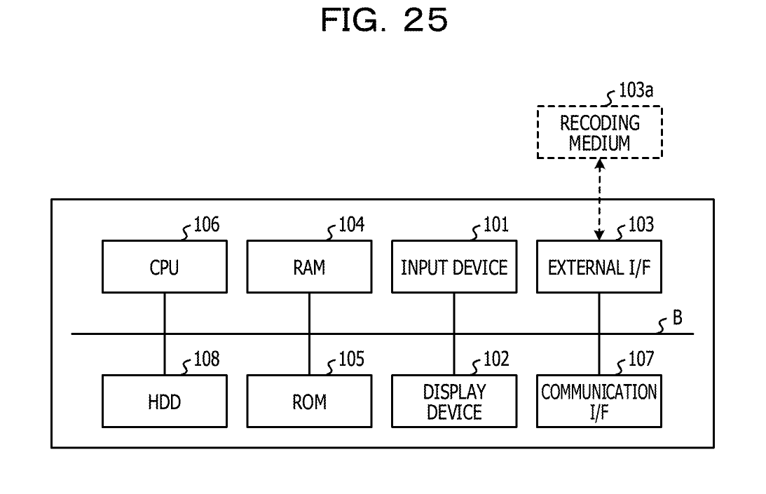

FIG. 25 illustrates one example of a hardware configuration of the incremental learning management device. The incremental learning management device 1 includes an input device 101, a display device 102, an external interface (I/F) 103, a random access memory (RAM) 104, a read only memory (ROM) 105, a central processing unit (CPU) 106, a communication I/F 107, and a hard disk drive (HDD) 108. The components are coupled with each other by a bus B.

The input device 101 includes a keyboard, a mouse, and so forth and is used to input operating signals to the incremental learning management device 1. The display device 102 includes a display and so forth and displays various kinds of processing results.

The communication I/F 107 is an interface that couples the incremental learning management device 1 with the network. The incremental learning management device 1 thereby performs data communication with other apparatuses via the communication I/F 107.

The HDD 108 is a non-volatile storage device that stores programs and data. The stored programs and data may include basic software that controls wholly the device and application software. For example, the HDD 108 stores various kinds of DB information, programs, and so forth.

The external I/F 103 is an interface with external devices. The external devices may include a recording medium 103a and so forth. The incremental learning management device 1 performs readout from and/or writing in the recording medium 103a via the external I/F 103. The recoding medium 103a may include compact disks (CD), digital versatile disks (DVD), SD memory cards, universal serial bus memories (USB memory), and so forth.

The ROM 105 is a non-volatile semiconductor memory (storage device) that is capable of retaining internal data even if the ROM 105 is powered off. The ROM 105 stores programs and data about network settings and so forth. The RAM 104 is a volatile semiconductor memory (storage device) that temporarily retains programs and data. The CPU 106 may be a computing device that reads out programs and data to the RAM 104 from the storage devices, for example, the “HDD 108”, the “ROM 105”, and so forth, executes processing, and thereby realizes control of the device wholly and installed functions.

The incremental learning management device 1 manages the incremental learning device 2 by using the hardware configuration. For example, the CPU 106 executes an optimization process of window size/sampling rate (N/S) by using the data and programs that are stored in the ROM 105 and the HDD 108. Thus, the window size and the sampling rate are variably set within the restricting range of the learning time in accordance with the input rate by the incremental learning device 2, and the learning result with high learning accuracy may thereby be obtained. Information about the learning history information table 121, the learning time prediction model table 122, the accuracy history information table 123, and the accuracy prediction model table 124 may be stored in a cloud server or the like that is coupled with the incremental learning management device 1 via the RAM 104, the HDD 108, or the network.

The functions of the incremental learning management device may be configured with hardware, software, or a combination of hardware and software.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An incremental learning management method comprising:
extracting data by a computer from input data that are sequentially input based on a first window size and a first sampling rate;
storing learning history information in which the first window size is associated with a learning time for the data and the first sampling rate;
measuring a data rate of the input data; and
calculating a second window size and a second sampling rate based on the data rate, the learning history information, and the first sampling rate.

2. The incremental learning management method according to claim 1, further comprising:
generating a model of the learning time based on the learning history information; and
calculating the second window size and the second sampling rate from the model of the learning time based on the data rate.

3. The incremental learning management method according to claim 1, further comprising:
finishing calculation of the second window size and the second sampling rate and changing the first window size and the first sampling rate to the second window size and the second sampling rate that are calculated last, in a case where accuracy of incremental learning in accordance with the first sampling rate is a threshold value or less.

4. The incremental learning management method according to claim 1, further comprising:
calculating a new second window size and a new sampling rate as the second window size and the second sampling rate, in a case where accuracy of incremental learning in accordance with the first sampling rate is greater than a threshold value.

5. An incremental learning management device comprising:
a memory configured to store a program; and
a processor configured to execute the program,
wherein the processor is configured to:
extract data from input data that are sequentially input based on a first window size and a first sampling rate;
store learning history information in which the first window size is associated with a learning time for the data and the first sampling rate;
measure a data rate of the input data; and
calculate a second window size and a second sampling rate based on the data rate, the learning history information, and the first sampling rate.

6. The incremental learning management device according to claim 5,
wherein the processor is configured to:
generate a model of the learning time based on the learning history information; and
calculate the second window size and the second sampling rate from the model of the learning time based on the data rate.

7. The incremental learning management device according to claim 5,
wherein the processor is configured to finish calculation of the second window size and the second sampling rate and changes the first window size and the first sampling rate to the second window size and the second sampling rate that are calculated last, in a case where accuracy of incremental learning in accordance with the first sampling rate is a threshold value or less.

8. The incremental learning management device according to claim 5,
wherein the processor is configured to calculate a new second window size and a new sampling rate as the second window size and the second sampling rate, in a case where accuracy of incremental learning in accordance with the first sampling rate is greater than a threshold value.

9. A computer readable recording medium storing an incremental learning management program, the program causing a computer to perform operations of:
extracting data from input data that are sequentially input based on a first window size and a first sampling rate;
storing learning history information in which the first window size is associated with a learning time for the data and the first sampling rate;
measuring a data rate of the input data; and
calculating a second window size and a second sampling rate based on the data rate, the learning history information, and the first sampling rate.

10. The computer readable recording medium according to claim 9, further comprising:
generating a model of the learning time based on the learning history information; and
calculating the second window size and the second sampling rate from the model of the learning time based on the data rate.

11. The computer readable recording medium according to claim 9, further comprising:
finishing calculation of the second window size and the second sampling rate and changing the first window size and the first sampling rate to the second window size and the second sampling rate that are calculated last, in a case where accuracy of incremental learning in accordance with the first sampling rate is a threshold value or less.

12. The computer readable recording medium according to claim 9, further comprising:
calculating a new second window size and a new sampling rate as the second window size and the second sampling rate, in a case where accuracy of incremental learning in accordance with the first sampling rate is greater than a threshold value.
